(19) United States
(12) Patent Application Publication
(10) Pub. No.: US 2011/0100208 A1
(43) Pub. Date: May 5, 2011

(54) Air pump producing high pressure

(76) Inventor: Bahtiyar Tasyagan, Kemalpasa Izmir (TR)

(21) Appl. No.: 13/002,347

(22) PCT Filed: Aug. 13, 2008
(86) PCT No.: PCT/TR2008/000097

§ 371 Date: Jan. 6, 2011

(51) Int. Cl. F15B 15/14

(52) U.S. Cl. 92/117 R

(57) ABSTRACT

Manually operated air pump for multistage compression of ambient air comprises a multiple coaxial cylinder arrangement. The air inlet (3) is located in the pump handle (2), through which air passes to enter the pump. The pump handle further includes a dust and humidity filter (21) and a cavity (20) to be used as tool storage.

### TECHNICAL FIELD

This invention is related to the air pump producing high pressure that provides to the users more efficient and ergonomic use in the ground conditions.

### BACKGROUND ART

Nowadays; there are pumps which produce high pressure for filling guns and aqualungs. The working process of these pumps is as follows; there are chambers build up in the air pump which are conjoined from bigger to smaller; the air which get into the air pump will guided to the biggest chambers through to the smallest chamber and fill in to the tubes with high pressure.

For example in U.S. Pat. No. 5,885,061; it was mentioned that the air which get through from pump body into the pump; guided to the chambers in order from bigger chambers to the smaller chamber and fill in to the tubes.

Also in U.S. Pat. No. 6,702,556; it was also mentioned that the air which get into the air pump is guided through the chambers by air valves and o-rings and fill into the tubes as intended

But in above-mentioned patent specifications; there are no mentioned barometers or any other gauge which consist the pressure when the air which guided through the bigger chamber to the smaller chamber fill into the tubes; also there are no filters mentioned which provide the infiltration of the air from dust and such materials before the air get into the pump.

Technically; according to these reasons some improvements had been made; one of those improvements is English Patent Specification number GB 239 8354 that; the air which get into the pump first infiltrated by an air filter and guided through the bigger chamber to the smaller chamber by the air valves and o-rings and fill into the tubes as intended. Also there is a barometer which consist the pressure in this specifications.

Also known that within the air pump producing high pressure; it is mentioned that there are air pump producing high pressure which include stuff reservoir to provide parts to be put in; make the pump pillar more ergonomic for the user and provide fast and easy demountable.

### BRIEF DESCRIPTION OF THE INVENTION

The object of this invention is; to produce a high pressure air filter that contains a reservoir in the pump handle which provides more comfortable and ergonomic usage and also provide more efficient usage because of the air filter is build in the pump handle.

Another object of this invention is; to produce an easily disconnected/connected air pump producing high pressure for the users in ground conditions.

Another object of the invention is to provide an air pump producing high pressure the pump pillar of which provides ergonomic usage to the users.

### DETAILED DESCRIPTION OF THE INVENTION

To reach the aim of this invention; the high pressure air pomp is shown as attached figures;

From this figures;

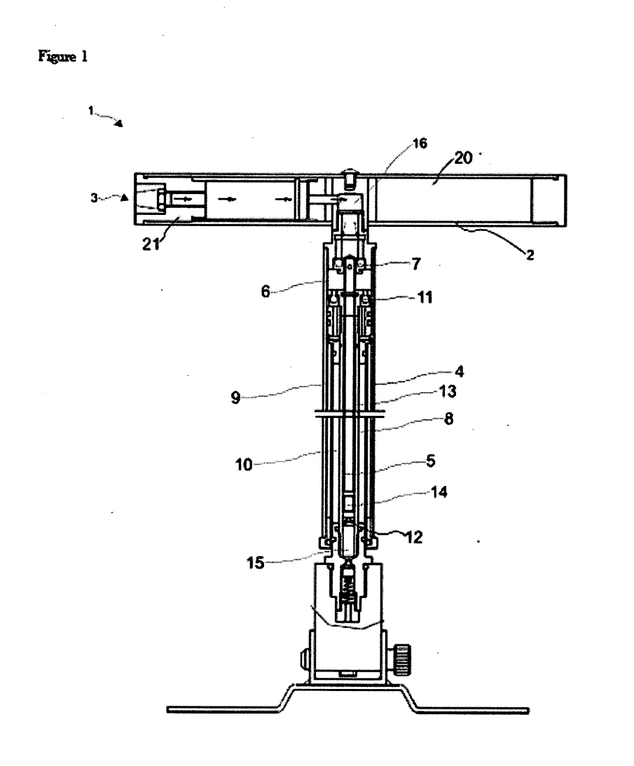

FIG. 1 is a vertical sectional view of the invention related air pump producing high pressure.

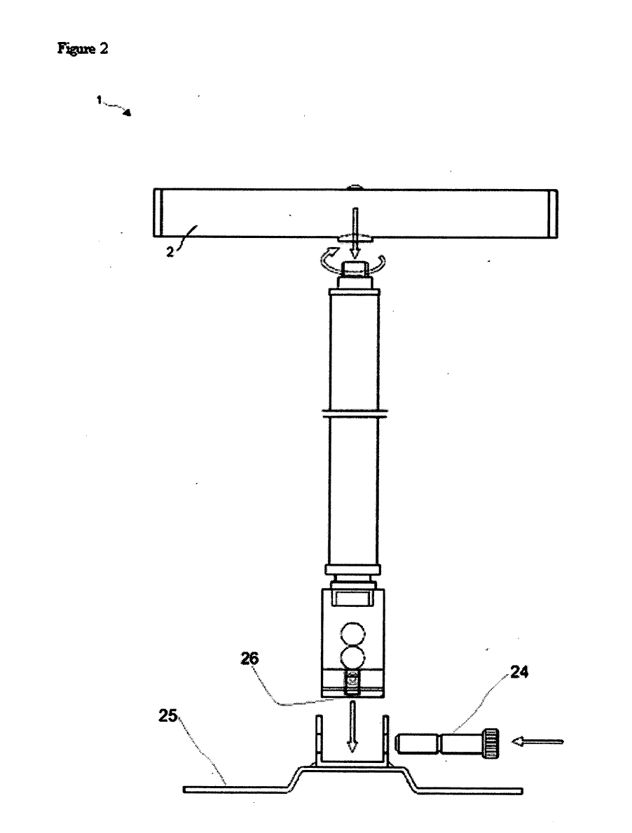

FIG. 2 is an exploded schematic view of the invention related air pump producing high pressure.

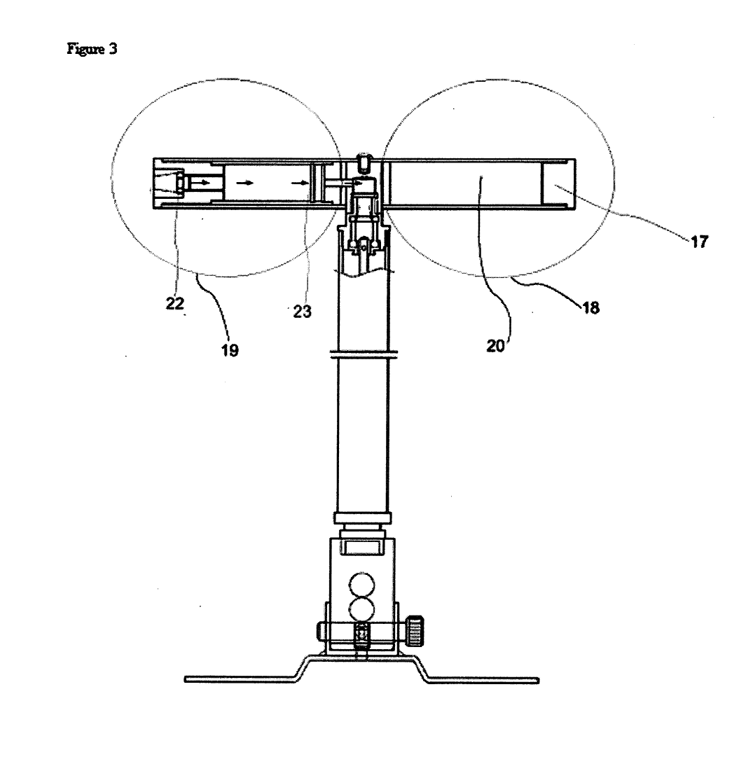

FIG. 3 is another perspective view of the invention related air pump producing high pressure.

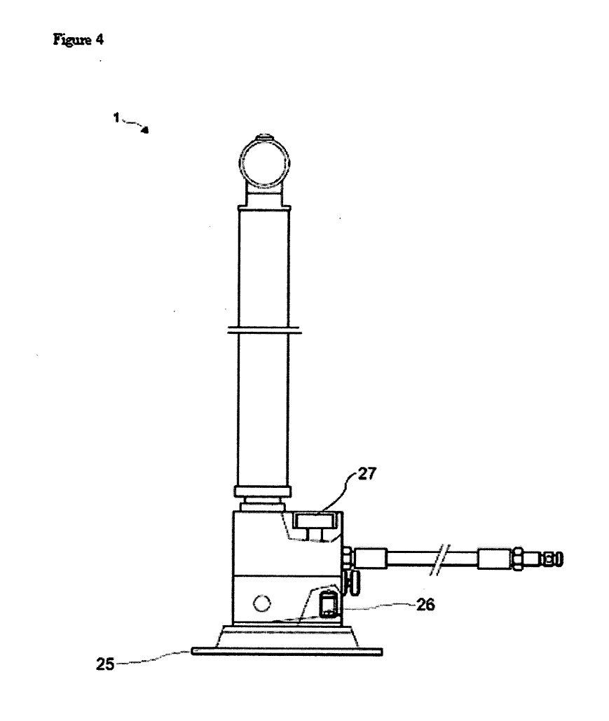

FIG. 4 is a perspective view of the pump parts which are mounted to the invention related air pump producing high pressure.

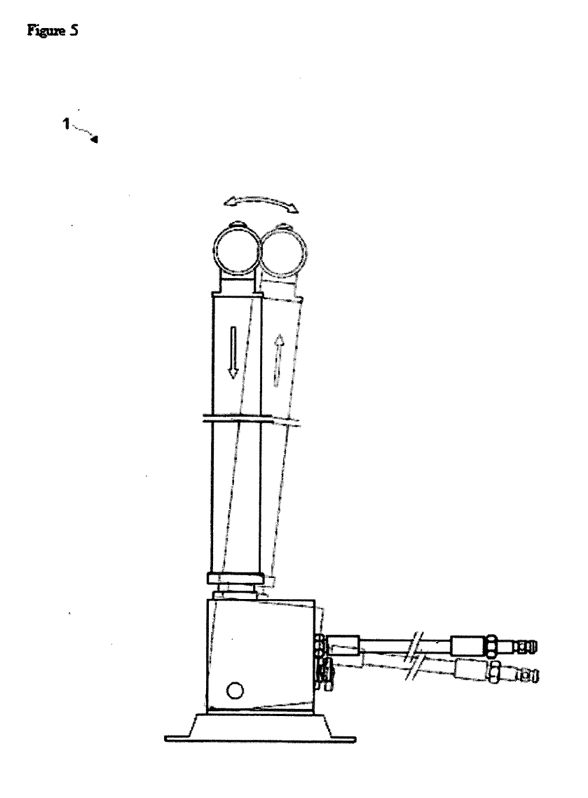

FIG. 5 is a perspective view of the hinge of invention related air pump producing high pressure during action.

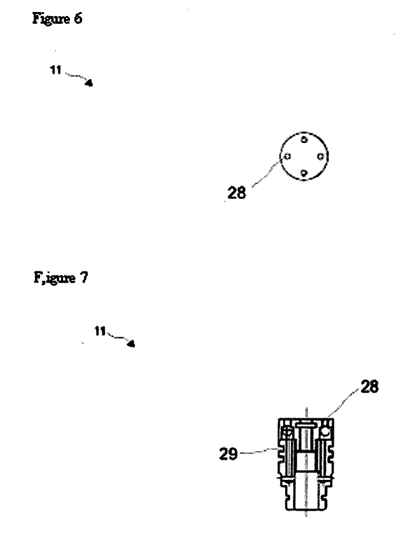

FIG. 6 is a top view of the air direction valve of the invention related air pump producing high pressure.

FIG. 7 is a side view of the air direction valve of the invention related air pump producing high pressure.

The parts of the above-mentioned air pump producing high pressure are numbered and listed as below;

1. Air pump producing high pressure

2. Handle

3. Slot

4. External pipe

5. Piston rod

6. First chamber

7. Air inlet valve

8. Second standpipe

9. Second chamber

10. Third chamber

11. Air direction valve

12. Moving o-ring

13. First standpipe

14. Piston

15. Fourth chamber

16. Connector

17. Cover

18. First part

19. Second part

20. Reservoir

21. Air filter

22. First filter cartridge

23. Second filter cartridge

24. Dowel

25. Mooring pin

26. Screw

27. Pressure gauge

28. Gutter

29. Standing o-ring

The above-mentioned air pump producing high pressure (1) contains; the first chamber (6) which filled with air through the air inlet slot (3) which lets the air get into the pump through to the chamber by pulling the pump handle upwards; also build in between the movable external pipe (4) and the piston rod (5); air inlet valve (7) which is closed by the pressure in itself when the pump handle (2) is pushed; the second chamber (9); in which the air in the first chamber (6) get in through open air direction valves (11); also build in between movable external pipe (4) and the second standpipe (8); the third chamber (10) built in between the first stand pipe (13) and the piston rod (5); the smallest volume fourth chamber (15); built in at the far end of the first stand pipe (13); (which is the last place where the air in second chamber and the third chamber passes through last before the tube when the direction valves closed because of the pressure occurs when the pump handle pulled upwards again and valve with the movable o-ring on the piston rod opened); and the piston (14); the pump handle (2); which have a dust and dump filter; a reservoir; and guide the air in the fourth chamber to get through the tube by closing the o-ring (12) valve to avoid the air passes through the second and third chamber when pushed again.

Air direction valve (11) contains a gutter which has spherical elements to guide the air pass through the chambers and at least an o-ring which separates the chambers from themselves.

Pump handle (2) separated into two part by the pump connector (16) which mounted in the middle of the handle; also contains the reservoir (20) which is placed under the cover (17) on the first section (18) of the handle and an air filter (21) which infiltrate the dust and the damp of the air which get into the second section (19).

User can put the maintenance and repair kit and spare parts or any other stuff into the reservoir and carry in a safe condition.

Air filter (21) of the invention related air pump producing high pressure (1); contains the first filter cartridge (22) which infiltrate the dust of air and the second filter cartridge (23) which infiltrate the dump of air.

The first filter cartridge (22) and the second filter cartridge (23) can be easily removed after a certain period and also easily replaced with the new ones by the user.

Invention related air pump producing high pressure (1); pump handle (2) can be removed from the body by revolving; pillar (25) can be removed from body by pulling the dowel; hereby pump (1) can be easily demountable.

Invention related air pump producing high pressure (1) contains an adjustment screw (26) which mounted between the pillar (25) and the body and also can be adjust according to the user's joint movements so user can move and use the pump (1) more easily.

The pressure gauge (27) of the invention related air pump producing high pressure (1); is embedded into the body to avoid external damages for example when the pump (1) is dropped down.

In the scope of this basic concept, it is probable for various implementations to be developed about the invention related air pump producing high pressure (1), the invention cannot be limited to the examples described here, it is as explained in the claims basically.

1. An air pump producing high pressure (1), comprising the biggest volume first chamber (6) positioned between the movable outer pipe (4) and the piston rod (5), filled with the first air by means of passing through the air inlet slot (3) enabling the air on the arm (2) to enter by means of pulling the handling arm (2) upwards; the second chamber (9) positioned between the movable outer pipe (4) at a smaller volume and the second standpipe (8) where the air passes through the first chamber (6) by means of the air direction valves (11) opening and the air inlet valves (7) closing by means of compressing the air by pushing the handling arm (2); the third chamber (10) positioned between the first standpipe (8) and the piston rod (5); the fourth chamber (15) at the smallest volume positioned at the end of the piston (14) and the first standpipe (13) where the air in the second and the third chambers passes lastly before the tube by means of the valve with movable o-ring (12) member at the piston rod (5) being opened and the air direction valves (11) being closed by means of the pressure occurring as a result of pulling the handling arm (2) upwards again; the air in the fourth chamber (15) is provided to pass to the tube by means of preventing the air to pass to the second and the third chambers by the valve with o-ring (12) member being closed when the handling arm (2) is pulled again; characterized in that a handling arm (2) having a sump for the filter of dust and humidity and tools to be put.

2. An air pump producing high pressure (1) according to claim 1; characterized in that it has at least one channel (28) having global members enabling the air passage through the chambers, and an air direction valve (11) having at least one standing o-ring (29) member separating the chambers.

3. The handling arm (2) is separated to two parts by means of the pump connection member (16) on the middle of it; an air pump producing high pressure (1) according to claim 1; characterized in that it comprises a tool storage (20) where the tools are put by means of taking off the cap (17) positioned at the butt of the first part (18) and an air filter (21) straining the deposit and the humidity of the air entering first in the second part (19).

4. An air pump producing high pressure (1) according to the previous claims; characterized in that it has an air filter (21) comprising first filter member (22) straining the deposits of the air entering first and a second air filter member (23) straining the humidity.

5. The handling arm (2) is separated from the body by means of rotating, and the body is separated from the pillar (25) by means of pulling the mooring pin (24). Therefore, an air pump producing high pressure (1) according to claim 1; characterized in that the pump (1) can be more easily disconnected/connected.

6. An air pump producing high pressure (1) according to claim 1; characterized in that it has an arrangement screw (26) positioned between the body and the pillar (25) and enabling the user to use the pump (1) by moving more easily by means of being arranged according to the joint (linkage) movement of the user.
